(19) United States
(12) Patent Application Publication
(10) Pub. No.: US 2010/0099290 A1
(43) Pub. Date: Apr. 22, 2010

(54) Axial anti-rotation coupling

(76) Inventor: Douglas Reid Gastineau, Costa Mesa, CA (US)

Correspondence Address: LEON D. ROSEN;FREILICH, HORNBAKER & ROSEN, Suite 1220, 10960 Wilshire Blvd., Los Angeles, CA, 90024, US

(21) Appl. No.: 12/288,505

(22) Filed: Oct. 21, 2008

(51) Int. Cl. H01R 13/622

(52) U.S. Cl. 439/321

(57) ABSTRACT

A mechanism of low cost and easy mounting, provides resistance to rotation of a coupling nut (14) of an electrical connector about the barrel (12) of the connector, and provides a higher resistance to rotation in one direction (U) than the opposite direction (M). A toothed ring (44) with a circle of teeth, is fixed to the barrel. The mechanism includes a washer (42) with projections (70, 72) that engage the teeth of the ring to ride over them during nut rotation, and thereby provide resistance to nut rotation. The washer is bent to form a spring to bias its projections against the teeth of the toothed ring. The washer also has ears (75, 76) that fit into slots in the nut to prevent washer rotation relative to the nut. The teeth of the toothed ring have first sides that are steeper than its second sides to provide higher resistance to rotation in one direction.

### BACKGROUND OF THE INVENTION

One type of electrical connector includes a barrel on which is mounted an insulative body with passages that hold wires and contacts. A coupling nut is rotatably mounted on the barrel so the nut can be rotated to thread it onto a mating second connector that has mating contacts. It is usually desirable to allow nut rotation with only a moderate resistance in a first direction to move the connectors together to mate, and to provide a much higher resistance to nut rotation in the opposite second direction to move the connectors apart to unmate. One type of mechanism includes a ring with projections for engaging a ring of teeth on the barrel, and a wave spring that biases the ring and its projections against the teeth. Pins extending thorough the ring prevent its rotation relative to the barrel. The need for two or three different parts that each must be mounted, adds to the complexity and cost of the connector.

### SUMMARY OF THE INVENTION

In accordance with one embodiment of the invention, an electrical connector is provided which has a coupling nut rotatable about a barrel, around a connector axis that extends in forward and rearward directions. The connector also has a simple and low cost mechanism for regulating resistance to nut rotation. The mechanism provides low resistance to nut rotation in a first direction for mating to another connector, and provides a higher resistance to nut rotation in an opposite second direction for unmating.

The barrel has a circle of teeth. The mechanism includes a control washer that is bent to form a spring, with opposite front locations resting against a forward-facing surface on the nut, and with opposite rear locations biased against the circle of teeth. The teeth of the circle of teeth have opposite teeth sides that are inclined by different amounts to the forward direction to provide different resistances to nut rotation.

The control washer rear locations are bent into loops that form rearward projections that press against the circle of teeth. The washer has ears that extend radially outward into slots formed in the nut, to prevent rotation of the washer. The control washer replaces the plurality of parts previously used, to reduce cost of manufacture and cost of installation.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an exploded isometric view of a connector of the present invention.

FIG. 2 is a sectional view of the assembled connector of FIG. 1.

FIG. 3 is a greatly enlarged view of a portion of FIG. 2.

FIG. 4 is a rear elevation view of the control washer of FIG. 2.

FIG. 5 is a side elevation view of the control washer of FIG. 4, showing the washer in its undeflected position in phantom lines, and in its deflected position in solid lines.

FIG. 6 is bottom view of the washer of FIG. 4.

### DESCRIPTION OF THE INVENTION

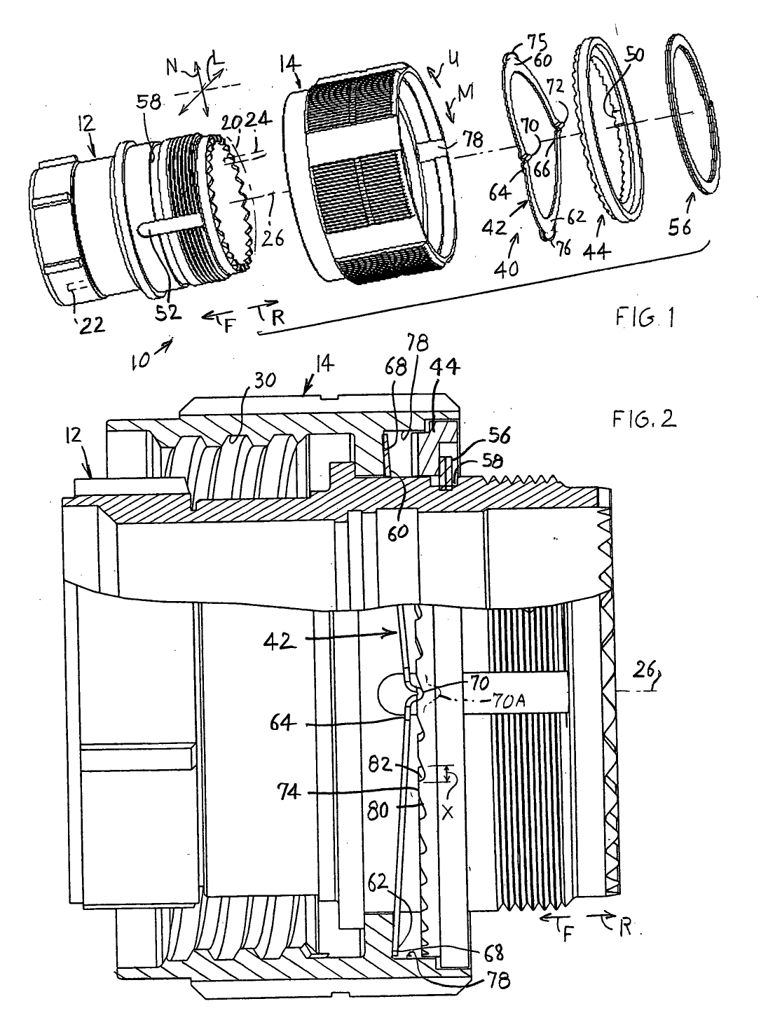

FIGS. 1 and 2 show an electrical connector 10 of the present invention which includes a barrel element 12 and a coupling nut element 14. The barrel 12 is used to mount a dielectric body 20 that holds contacts 22 and wires 24. The connector has a connector axis 26. The nut 14 is rotatable by hand about the barrel, and the nut has internal threads 30 that receive a threaded mating connector (not shown) to mate thereto. During mating, the nut 14 is turned in a mating direction M to advance the connector 10 in a mating, or forward F direction, and during unmating the nut is turned in the unmating direction U to move the connector in the unmating, or rear direction R.

It is desirable to provide moderate resistance to turning of the coupling nut during mating. However, it is desirable to provide a much higher resistance to turning of the nut during unmating to prevent unintentional nut turning and corresponding unintentional unmating of the connectors. The connector includes a mechanism 40 for accomplishing this. The mechanism includes a control washer 42, formed by an initially flat thin ring, that is centered on the axis 26 and that controls resistance to turning of the nut. A toothed ring 44 is mounted to rotate with the barrel, while allowing the toothed wheel to slide parallel to the axis. The toothed ring 44 has a pair of axially-extending grooves 50 that receive axially-extending projections 52 on the barrel. The projections 52 lock the toothed ring against rotation relative to the barrel, while allowing the toothed ring to slide forward and rearward which facilitates assembly and disassembly. A common snap ring 56 that snaps into a groove 58 on the outside of the barrel, holds the tooth ring on the barrel.

The control washer has a top and bottom (as seen in FIGS. 1 and 2) forming longitudinally N spaced front resting locations 60, 62 and the washer has laterally L spaced opposite rear sides 64, 66. The resting locations rest on portions of a rearward-facing washer-support surface 68 of the coupling nut that lie a distance forward of the toothed ring and that face the toothed ring. The washer is bent, with the opposite rear sides 64, 66 lying a distance rearward R of the front resting locations 60, 62. The rear sides 64, 66 have rearward projections or bumps 70, 72 that project rearward and engage the teeth of the toothed ring 44. The projections are circumferentially spaced (about axis 26), as are the rear sides. The washer also has radially-projecting ears 75, 76 that project into slots or notches 78 in the coupling nut to prevent relative rotation of the washer in the nut.

FIG. 2 shows the control washer after it has been installed, showing that the teeth 74 of the toothed ring have teeth sides 80, 82 that are circumferentially (with respect to axis 26) spaced. One side 80 of each tooth extends at a large incline to the axial direction (direction of axis 26) and the other side 82 extends at a much smaller incline. The washer projections such as 70 initially lie at position 70A, but are pushed forward F to position 70 when the toothed ring 44 and snap ring 56 are installed. As a result, the control washer serves as a spring that biases its projections against the toothed ring 44 which, in turn, is biased against the snap ring 56.

Each of the washer projection 70, 72 (FIG. 4) are formed by bending a washer location in a half circle with transitions to form a projecting loop. The loop preferably extends across the radial width W of the ring that forms the washer. The washer width W is a plurality of times its thickness T. The teeth of the toothed wheel have a constant shape across their radial width (X, FIG. 2). As a result, there tends to be area contact (rather than point contact) of each projection 70, 72 with the teeth of the toothed ring. It is possible to provide projections by welding on projections or by pressing out locations on the washer to form projections.

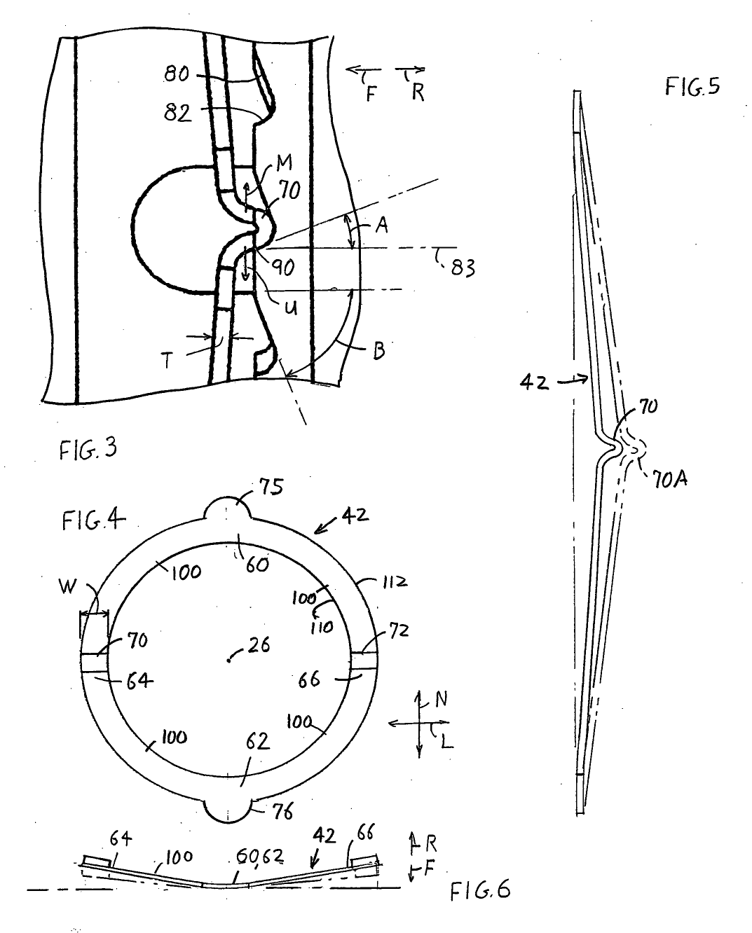

FIG. 3 shows that the top, or front end, of the steep side 82 of each tooth extends at an angle A of about 20° to a line 83 that is parallel to the axis. The projection 70 has a location 90 that engages the top of the steep side and that also extends at an angle A of about 20° to the axial direction. The shallow side 80 of each tooth extends at an angle B of about 70° to the axial direction. It takes much less force to move the projection 70 in the mating direction M than the unmating direction. The angle A is preferably no more than 30° while the angle B is preferably at least 30°.

FIG. 4 shows that the control washer 42 has primarily circular inner and outer edges 110, 112, and has a pair of radially outwardly extending ears 75, 76 at the rear resting location 60, 62 (and that are part of the resting locations). The inner edge 110 forms a primarily circular hole centered on the axis 26. FIG. 2 shows that the coupling nut has a pair of slots 78 that receive the ears, to prevent relative rotation of the control washer with respect to the nut 14. FIG. 6 shows that in a top or bottom view of the control washer 42, it can be seen that the washer is bent to place its opposite sides 64, 66 rearward of the top and bottom ends 60, 62, with inclined intermediate washer parts 100 connecting the sides and ends.

Thus, the control washer serves several purposes in a single element that can be made at low cost and that is easily installed. First, the washer forms projections that engage the toothed wheel to control resistance to coupling nut rotation in each turning direction M, U. Second, the washer serves as a spring that not only biases its projections into contact with the tooth wheel, but that biases the toothed wheel 44 against the snap ring 46, thereby eliminating the need for a separate spring washer or other biasing device. Third, the ears 75, 76 on the top and bottom of the washer fit into simple slots 78 in the nut to prevent rotation. The use of a single washer reduces the likelihood of failure of one of a few separate parts, while making installation easy and reducing cost.

Thus, the invention provides an electrical connector with a coupling nut that rotates about a barrel, which controls resistance to rotation in each direction in a simple mechanism. While the invention was developed for use with an electrical connector, it can be used for optical connectors, which are the equivalent. The washer is preferably formed from a bent piece of sheet metal that has a spring temper, although it possible to form it of plastic or other material. Although the washer is shown as having two opposite sides 64, 66 and two opposite ends 60, 62, it is possible to have three 120°-spaced sides and three 120°-spaced ends. It would be possible to use a first washer with projections for engaging the teeth of the toothed wheel and with projecting ears to prevent its rotation, and to use a separate second washer that is bent to form a spring that biases the first washer rearward, although this is not preferred.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. An electrical connector that includes a barrel element for holding a contact-mounting body, a coupling nut element extending around said barrel element and rotatable on said barrel element about an axis, and a mechanism coupled to said barrel and nut elements that resists rotation of the nut element in at least a first direction of rotation about said axis, wherein a first of said elements has a ring of teeth and the second element has rearward-facing support surface portions facing said teeth, and said apparatus includes a washer held against rotation relative to a second of said elements and engaged with said teeth to resist but allow relative rotation of said elements, wherein:
said washer is bent to form a plurality of circumferentially-spaced rear resting locations that rest against said rearward facing surface portions, and said washer has a plurality of circumferentially-spaced front washer locations spaced forward of said rear resting locations;
each of said front washer locations has a forward-projecting bump for engaging said teeth.

2. The connector described in claim 1 wherein:
said second element forms said flat surface portions and said second element has at least one radial notch extending radially from one of said flat surfaces;
said washer has radially inner and radially outer circular edges, and said washer has at least one ear projecting radially outward from one of rear resting locations into said notch.

3. The connector described in claim 1 wherein:
said teeth each have radial width (X) and a constant shape between said edges;
said washer has radially inner and radially outer primarily circular edges that form an annular band between them, and said bends that form bumps each extends across the entire annular width (W) of the band.

4. The connector described in claim 1 wherein:
said first element is said barrel element, and said ring of teeth is axially slidable on said barrel element but is not rotatable about said axis relative to said barrel element.

5. A connector that comprises elements including a barrel for holding a contact-mounting body and a coupling nut extending around and rotatable about an axis on the barrel, said connector including a ring of teeth held against rotation relative to a first of said elements and a mechanism that engages said teeth and the second of said elements to resist coupling nut rotation, wherein:
said mechanism includes a washer with a washer hole lying on said axis, said washer having a plurality of bends at each of a plurality of locations that are angularly spaced about said axis to form projections that project axially into engagement with said teeth, and means for biasing said projections axially against said teeth.

6. The connector described in claim 5 wherein:
said bends each forms a loop that extends in a half circle, with the washer and each bend each having a width (W) equal to the radial width of the washer adjacent to the bend.

7. The connector described in claim 5, wherein:
said nut forms a pair of rearward-facing support surface portions;
said means for biasing comprises bends in said washer that form longitudinally-spaced (N) front resting locations (60, 62) on opposite sides of said axis that rest against said support surface portions, and said projections lie on laterally (L) opposite sides of said axis, with said longitudinal and lateral directions being perpendicular to each other.

8. Apparatus for use with barrel and nut elements of a connector to fit between the nut and barrel element and allow the nut element to turn about a connector axis that extends in front and rear directions while resisting such turning, wherein said apparatus includes a ring of forward-projecting teeth with the ring being rotatable fixed to a first of said elements and the second element has a support surface that faces rearward, wherein:
said apparatus comprises a washer with a primarily circular hole and with a washer axis lying on said connector axis, said washer having a greater radial width (W) than its thickness (T), said washer being bent to form a plurality of angularly spaced washer rear end parts resting on said support surface, a plurality of angularly-spaced washer front ends lying forward of said washer rear ends, and a plurality of inclined intermediate washer parts that each extends between one of said rear ends and one of said front ends, said washer front end parts each has a bend that forms a rearward projection for engaging said teeth.

9. The apparatus described in claim 8 wherein:
said bends that form rearward projections are primarily in the form of half circles that extend across the entire radial width (W) of said washer.

10. The apparatus described in claim 8 wherein:
said second element has a pair of notches extending radially from said support surface, and said washer has a pair of radially outwardly projecting ears that fit into said notches.

11. The apparatus described in claim 8 wherein:
said ring of teeth is slidable along said axis relative to said first element.
